(19) United States
(12) Patent Application Publication
(10) Pub. No.: US 2025/0343427 A1
(43) Pub. Date: Nov. 6, 2025

(54) Method and System for Energy Resilience in a Building

(71) Applicant: ABB Schweiz AG, Baden (CH)

(72) Inventors: Huangjie Gong, Raleigh, NC (US); Samy Faddel Mohamed, Clayton, NC (US); Amanuel Melese, Cary, NC (US)

(73) Assignee: ABB Schweiz AG, Baden (CH)

(21) Appl. No.: 18/654,192

(22) Filed: May 3, 2024

(51) Int. Cl. H02J 7/00; H02J 9/06

(52) U.S. Cl. CPC H02J 7/0048; H02J 7/0071; H02J 9/068

(57) ABSTRACT

An indication of a power outage for a building is obtained. A battery of the building is dispatched to provide power to devices of the building based on the indication. A priority of devices to maintain at an on state as a state of charge for the battery decreases during the power outage is obtained from a user. A minimum state of charge for the battery and a maximum state of charge for the battery are obtained. A sequence for turning off each device, the state of charge of the battery available when a respective device of the devices is turned off, and a forecasted time period that each device of the devices will be provided the power from the battery before being turned off is determined. A signal is transmitted for actuating an actuator for a device of the devices to disconnect from the battery based on the sequence.

### FIELD

The present disclosure relates to a method and system for managing power consumption to improve the resilience of a building while maintaining occupant comfort during a loss of power to the building.

### BACKGROUND

It is logical to turn off as many appliances and devices as possible during a power outage. However, doing so might compromise the comfort of the occupant and some users might prefer to keep certain devices on to maintain comfort or security. Each user may have a different preference for which devices or appliances they would prefer to stay on during a power outage as well. Conventional methods do not provide a balance between providing electricity to a building or residence for a longer period of time and maintaining occupant comfort. To further complicate the issue, power outages could be a glitch which only lasts minutes or be a rolling blackout that lasts for hours. They can be caused by an unexpected fault or natural disaster that lasts for days or more. Although a residential battery could provide power to a building during a power outage it cannot do so indefinitely and without restricting which devices are drawing power it may last only a short time. Merely increasing the energy capacity and size of a residential battery is not practical because it could add significant costs and require more space to accommodate.

### SUMMARY

An embodiment of the present disclosure provides a computer-implemented method for managing power consumption including obtaining an indication of a power outage for a building, dispatching a battery of the building to provide power to one or more devices of the building based on the indication, obtaining, from a user, a priority of devices of the one or more devices to maintain at an on state as a state of charge for the battery decreases during the power outage, obtaining a minimum state of charge for the battery and a maximum state of charge for the battery, determining a sequence for turning off each device of the devices, the state of charge of the battery available when a respective device of the devices is turned off, and a forecasted time period that each device of the devices will be provided the power from the battery before being turned off based at least in part on the priority of devices, the minimum state of charge for the battery, the maximum state of charge for the battery, and a current state of charge of the battery, and transmitting a signal, sequentially, for actuating an actuator for a device of the devices to disconnect from the battery based on the sequence and the current state of charge of the battery available.

In an embodiment, the minimum state of charge for the battery and the maximum state of charge for the battery are specified by the user.

In an embodiment, the computer-implemented method further includes obtaining historic power consumption data for the one or more devices of the building from current sensors of the one or more devices, and determining the minimum state of charge for the battery and the maximum state of charge for the battery based on the historic power consumption data for the one or more devices.

In an embodiment, the computer-implemented method further includes providing, to a user device of the user, the forecasted time period that each device of the devices will be provided the power from the battery before being turned off.

In an embodiment, the computer-implemented method further includes updating the forecasted time period as each device of the devices is turned off, and providing, to the user device of the user, the updated forecasted time period.

In an embodiment, the computer-implemented method further includes transmitting other signals for actuating actuators of the devices to turn the devices to the on state based on receiving another indication that the power outage for the building has ceased.

In an embodiment, the computer-implemented method further includes transmitting instructions to charge the battery from a power source of the building based on the another indication that the power outage for the building has ceased.

In an embodiment, the computer-implemented method further includes receiving, from a utility provider, a time period for a planned power outage for the building, wherein determining the sequence, the state of charge of the battery available when the respective device of the devices is turned off, and the forecasted time period that each device of the devices will be provided the power from the battery before being turned off is further based on receiving the time period for the planned power outage.

In an embodiment, the computer-implemented method further includes transmitting instructions to charge the battery for the building to the maximum state of charge prior to the time period for the planned power outage based on receiving the time period.

In an embodiment, the computer-implemented method further includes obtaining historic power consumption data for the one or more devices of the building from current sensors of the one or more devices during a period of time, first information associated with planned power outages for the building during the period of time, and historic weather related information for an area associated with the building during the period of time, training a supervised machine learning algorithm to predict a forecasted power outage using the historic power consumption data, the first information, and the historic weather related information, and transmitting instructions to charge the battery for the building to the maximum state of charge based at least in part on the forecasted power outage.

In an embodiment, the supervised machine learning algorithm is further configured to determine the maximum state of charge for the battery for the forecasted power outage using the historic power consumption data.

Another embodiment of the present disclosure provides a computer system for managing power consumption, the computer system including one or more hardware processors which, alone or in combination, are configured to provide for execution of the following steps: obtaining an indication of a power outage for a building, dispatching a battery of the building to provide power to one or more devices of the building based on the indication, obtaining, from a user, a priority of devices of the one or more devices to maintain at an on state as a state of charge for the battery decreases during the power outage, obtaining a minimum state of charge for the battery and a maximum state of charge for the battery, determining a sequence for turning off each device of the devices, the state of charge of the battery available when a respective device of the devices is turned off, and a forecasted time period that each device of the devices will be provided the power from the battery before being turned off based at least in part on the priority of devices, the minimum state of charge for the battery, the maximum state of charge for the battery, and a current state of charge of the battery, and transmitting a signal, sequentially, for actuating an actuator for a device of the devices to disconnect from the battery based on the sequence and the current state of charge of the battery available.

In an embodiment of the computer system, the steps further include obtaining historic power consumption data for the one or more devices of the building from current sensors of the one or more devices, and determining the minimum state of charge for the battery and the maximum state of charge for the battery based on the historic power consumption data for the one or more devices.

In an embodiment of the computer system, the steps further include providing, to a user device of the user, the forecasted time period that each device of the devices will be provided the power from the battery before being turned off.

In an embodiment of the computer system, the steps further include updating the forecasted time period as each device of the devices is turned off, and providing, to the user device of the user, the updated forecasted time period.

In an embodiment of the computer system, the steps further include transmitting other signals for actuating actuators of the devices to turn the devices to the on state based on receiving another indication that the power outage for the building has ceased.

In an embodiment of the computer system, the steps further include receiving, from a utility provider, a time period for a planned power outage for the building, wherein determining the sequence, the state of charge of the battery available when the respective device of the devices is turned off, and the forecasted time period that each device of the devices will be provided the power from the battery before being turned off is further based on receiving the time period for the planned power outage.

Another embodiment of the present disclosure provides a tangible, non-transitory computer-readable medium having instructions thereon which, upon being executed by one or more processors, provide for managing power consumption by execution of the following steps: obtaining an indication of a power outage for a building, dispatching a battery of the building to provide power to one or more devices of the building based on the indication, obtaining, from a user, a priority of devices of the one or more devices to maintain at an on state as a state of charge for the battery decreases during the power outage, obtaining a minimum state of charge for the battery and a maximum state of charge for the battery, determining a sequence for turning off each device of the devices, the state of charge of the battery available when a respective device of the devices is turned off, and a forecasted time period that each device of the devices will be provided the power from the battery before being turned off based at least in part on the priority of devices, the minimum state of charge for the battery, the maximum state of charge for the battery, and a current state of charge of the battery, and transmitting a signal, sequentially, for actuating an actuator for a device of the devices to disconnect from the battery based on the sequence and the current state of charge of the battery available.

In an embodiment of the non-transitory computer-readable medium, the steps further including providing, to a user device of the user, the forecasted time period that each device of the devices will be provided the power from the battery before being turned off.

In an embodiment of the non-transitory computer-readable medium, the steps further including transmitting other signals for actuating actuators of the devices to turn the devices to the on state based on receiving another indication that the power outage for the building has ceased.

### BRIEF DESCRIPTION OF THE DRAWINGS

The present disclosure will be described in even greater detail below based on the exemplary figures. The disclosure is not limited to the exemplary embodiments. All features described and/or illustrated herein can be used alone or combined in different combinations in embodiments of the disclosure. The features and advantages of various embodiments of the present disclosure will become apparent by reading the following detailed description with reference to the attached drawings which illustrate the following:

FIG. 1 illustrates an example of a control unit in a smart panel that connects to a power grid for managing power consumption according to embodiments described herein;

FIG. 2 illustrates an example flow chart for managing power consumption according to embodiments described herein;

FIG. 3 illustrates an example graph depicting certain aspects of the managing power consumption features according to embodiments described herein;

FIG. 4 illustrates an example mapping of input to state of charge of the battery to forecasted time for managing power consumption features according to embodiments described herein;

FIG. 5 illustrates an example graph depicting certain aspects of the managing power consumption features including formulas according to embodiments described herein;

FIG. 6 illustrates an example table depicting users defining preferences and priorities of appliances as input and a forecasted time to be provided as output along with example formulations used to determine the forecasted time according to an embodiment of the present disclosure;

FIG. 7 illustrates an example flow chart for managing power consumption according to embodiments described herein; and

FIG. 8 illustrates a simplified block diagram of one or more devices or systems for managing power consumption according to embodiments of the present disclosure.

### DETAILED DESCRIPTION

Embodiments of the present disclosure provide a method and system for managing power consumption. While the present disclosure is described primarily in connection with machines, systems, or components operated in a residence, as would be recognized by a person of ordinary skill in the art, the disclosure is not so limited and inventive features apply to other components or systems of other building such as businesses, warehouses, or industrial environments.

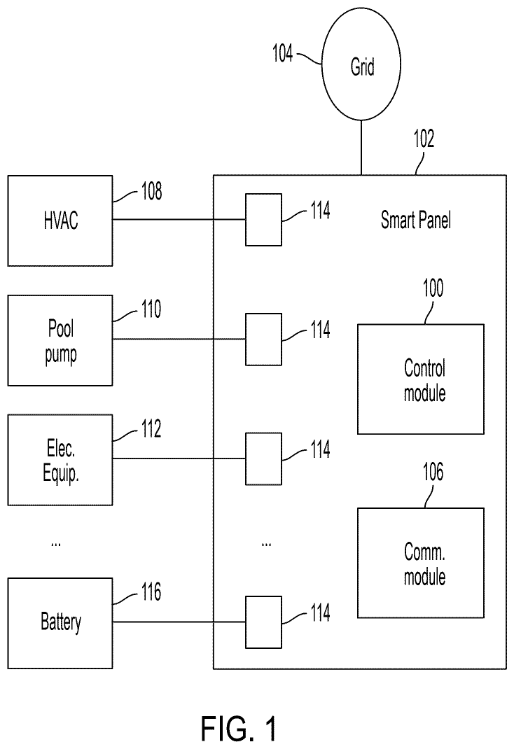

According to aspects of the present disclosure, a novel limiting power consumption system is described which provides solutions to problems associated with conventional power consumption limiting methods. For example, an apparatus, such as that depicted in FIG. 1, including a control unit or control module, can monitor and control the electricity consumption of appliances connected to its circuit branches and reduce the total power demand of a building during a power outage. For short-term power outages the novel features described herein can make the transition of energy source from the electricity grid to a building battery smoothly and efficiently. This is more desirable to conventional methods which may use backup generators as generators may require a certain amount of time to prepare and generation electricity thereby resulting in a sudden interruption when a power outage occurs. For a long-term power outage, the novel features described herein can improve the resilience of the building by decreasing the electricity usage by appliances/devices of the building during the power outage. The features described herein can improve over conventional methods by prolonging the self-sustained time of the building without increasing the energy capacity of the residential battery.

Conventional methods do not provide for accepting user priorities/preferences or provide for building resiliency in as accurate and efficient manner as the features described herein. For example, conventional methods may merely enable users to turn appliances or devices on or off during a power outage. Other conventional methods may enable users to categorize appliances and show the runtime of a battery or monitor the electricity usage by the battery. The novel managing power consumption features described herein provide improvements over the conventional methods by giving users the freedom to set a priority for each appliance and still show the runtime for each appliance during a power outage and map a user defined priority with a state of charge (SOC) at which the appliance should be turned off to increase building resiliency. The managing power consumption features described herein optimizes between occupant comfort and the self-sustained time of a building enabled by a battery and properly selects, automatically, the devices to be turned off during a power outage. These advantages are significant when compared to two conventional situations when a power outage occurs: the first situation uses the building battery as a power supply without any limiting of the electricity usage resulting in quick depletion of the battery energy; and the second situation turns off all non-critical devices without considering the needs of the occupant.

FIG. 1 illustrates an example of a control unit (module) 100 in a smart panel 102 that connects to a power grid 104 for managing power consumption according to embodiments described herein. In embodiments, the smart panel 102 may be located in a building or a proximal distance from the building and include components, such as the control unit 100, for managing power consumption according to embodiments described herein. The smart panel 102 may include communication module 106 for communicating with devices, such as devices 108-112, external entities such as utility providers or other third party entities. In embodiments, the smart panel 102 may include current or voltage sensors 114. As described herein the smart panel 102, control unit 100, and communication module 106 may communicate with battery 116 to dispatch the battery 116 during a power outage, send instructions or signals to charge the battery 116 from power grid 104, or estimate/calculate (obtain) status information such as a state of charge of the battery 116 via sensor 114.

It should be noted that although FIG. 1 depicts the control unit 100 being stored in a smart panel 102 the embodiments described herein are not limited to such an architecture or configuration. For example, data or information from the sensors 114 may be collected or obtained by the smart panel 102 and transmitted, via the Internet or cellular network to a control unit 100 located in a distant computer, server, or cloud computing environment. Additionally, the configuration depicted in FIG. 1 is not meant to limit the embodiments described herein as the control unit 100 and communication module 106 can interact with the sensors 114, devices 108-112, battery 116, and power grid 104 directly without the need for a smart panel 102. In embodiments, the smart panel 102 and/or control unit 100 may provide signals or instructions for actuating actuators (e.g., relays, breakers, pole breakers) for turning devices such as 108-112 on or off. The control unit 100 and communication module 106 may provide instructions or signals for interacting with smart devices or Internet of Things (IoT) devices to adjust a temperature or other setting for certain devices of a building to manage power consumption for the building.

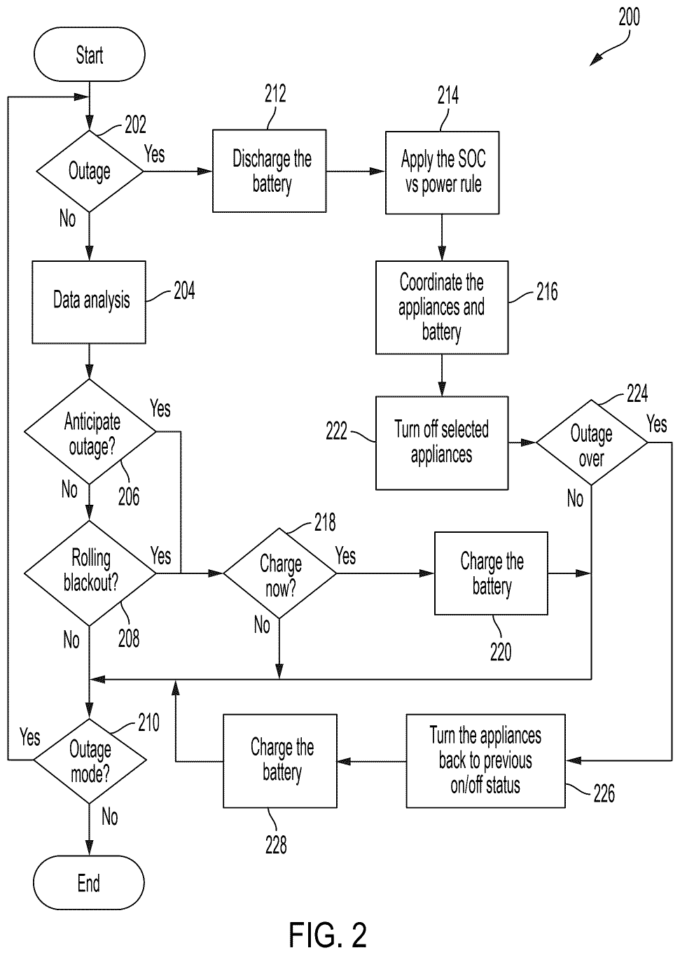

FIG. 2 illustrates an example flow chart 200 for managing power consumption according to embodiments described herein. As an overview of the managing power consumption features depicted in FIG. 2 by an outage event being detected by the control unit (controller) and signals or instructions being transmitted to dispatch the battery to provide power to a building. In most situations at the beginning of a power outage most devices of a building may be kept on and being provided power by the battery. As the state of charge (SOC) of the battery decreases, devices will be turned off in a proper sequence which is determined by a user or a default configuration is used. A control of the devices being provided power by the battery is achieved by an algorithm implemented by the control unit that takes into account the user preferences/priority and other data. The battery will supply the devices with power until the outage is over or when the state of charge reaches the minimum state of charge (minimum value). In embodiments, the battery will be charged to a maximum state of charge (maximum value) after the outage event has ended or ceased.

The flow chart 200 includes at 202 determining whether a power outage is occurring (detecting an outage event). The outage event can be detected or determined by the control unit identifying via sensors, such as voltage sensors, that the power grid is no longer providing electricity to the building. If there is no power outage at 202 the control unit may obtain data or information such as historic power consumption data for the devices during a prior time period, signals from utility providers about anticipated power outages or planned power outages, or historic weather related data for data analysis at 204. For example, the control unit may train, implement, and update a supervised machine learning algorithm for identifying a future period or forecasted power outage for the building as well as determine minimum and maximum states of charge for the battery. The flow chart 200 includes determining whether there is an anticipated power outage expected at 206 based on signals or communications from a utility provider or based on output from the supervised machine learning algorithm as described herein.

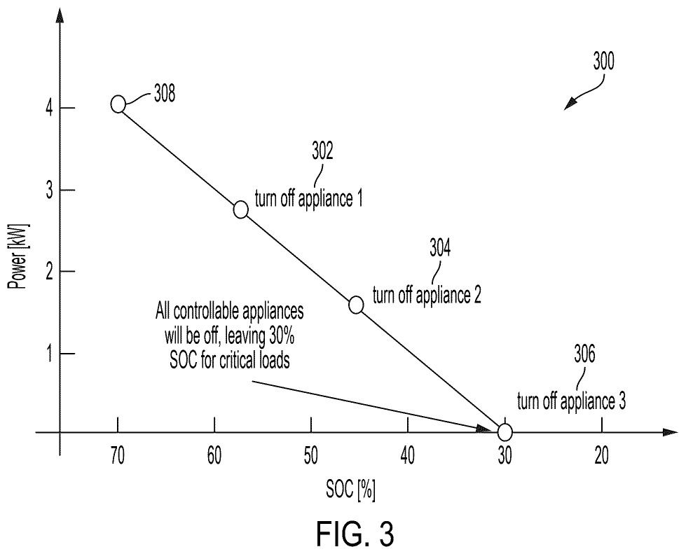

The flow chart 200 also determines whether a rolling blackout is occurring or scheduled at 208. If there is not a rolling blackout then the flow chart 200 includes determining whether the system is still in an outage mode (e.g., is power still not being supplied by the power grid to the building) at 210. In embodiments, the control unit may also utilize the historic consumption data and user behavior patterns of use of devices during periods when there is no power outage as well as when a power outage is occurring to determine if the battery should be charged to a certain level—such as the maximum state of charge. In scenarios where there is an anticipated power outage or the utility provider indicates that a rolling blackout will occur the control unit can instruct that the battery be charged to the maximum state of charge prior to the power outage 218 and 220. Turning back to the beginning of the flow chart 200, the control unit may provide instructions or signals to discharge the battery at 212. In embodiments, the control unit may implement an algorithm that applies or otherwise enforces a state of charge versus power rule at 214. This is described in more detail below with reference to FIGS. 3-6.

The flow chart 200 include coordinating the appliances/devices and the battery at 216 to obtain the state of charge of the battery and the status of devices (e.g., on, off, current power consumption). This information may be obtained or collected by the control unit from the sensors such as the current sensors associated with select devices and the battery. The flow chart 200 includes instructions or commands from the control unit to actuators of the devices selected according to the determined sequence and priority at 222. As will be described in more detail below instructions or commands may be provided to select device(s) at certain time points to increase the resiliency of the building during the power outage and maintain user comfort. The flow chart 200 includes at 224 determining whether the power outage is over. This may be determined by the control unit identifying whether power is once again being provided by the power grid to the building. If the outage is not over at 224 the flow chart goes back to the determination of the outage mode at 210. However, if the outage is over at 224 then the control unit may generate and transmit instructions to turn the appliances back to previous on/off status at 226. The control unit may again interact with actuators of the devices via commands or instructions to revert the devices back to a previous on/off state. The flow chart 200 includes at 228 the control unit to instruct the battery to be charged back to a maximum state of charge.

FIG. 3 illustrates an example graph 300 depicting certain aspects of the managing power consumption features according to embodiments described herein. The graph 300 of FIG. 3 depicts an implementation of the novel SOC versus power rule (curve) that is used by the control unit to coordinate the battery and the appliances and to achieve the maximum comfort of the occupant of the building. In the example depicted in FIG. 3 there are three controllable devices 302-306 and the battery has a 70% SOC 308 when the power outage occurs. The graph includes on the y-axis total power in kW for controllable devices 302-306 and state of charge (SOC) of the battery as a percentage on the x-axis.

In embodiments, the three devices 302-306 are turned off sequentially according to the SOC of the battery. For example, as depicted in FIG. 3 when the SOC decreases to approximately 60% the first appliance 302 is turned off. To continue the example, when the SOC decreases to approximately 45% the second appliance 304 is turned off. Finally, when the SOC decreases to approximately 30%, the third appliance 306 is turned off. Afterwards, the battery may supply the critical loads with the remaining amount of SOC which in this scenario is 30%. If the user had set the minimum SOC to 20% then the battery only supplies the critical loads when the range of the SOC is 20%. The critical loads are associated with devices that are not monitored or controlled by the control unit and may include such devices such as refrigerators, interior lights, ventilation fans, etc.

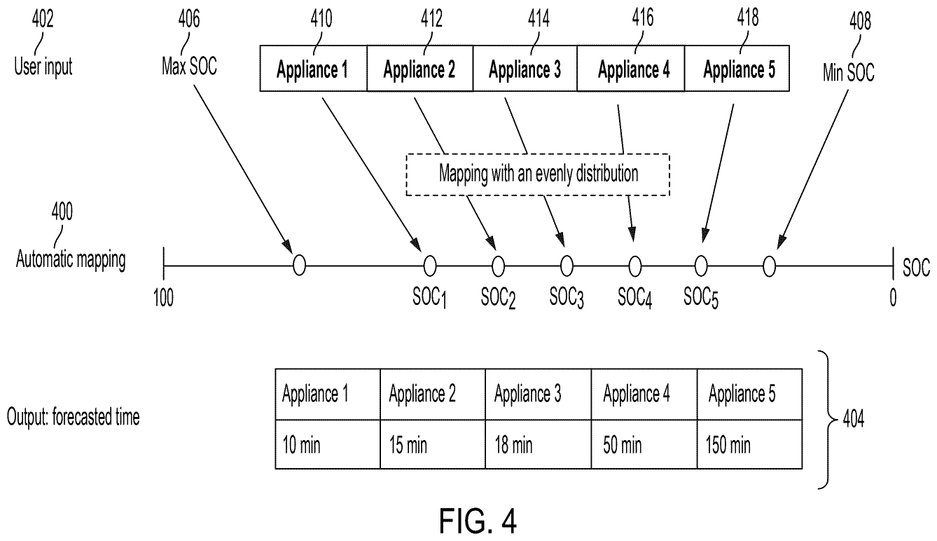

FIG. 4 illustrates an example mapping 400 of input 402 to state of charge of the battery to forecasted time 404 for managing power consumption features according to embodiments described herein. In embodiments, the control unit may assign default settings for the user for the priority of devices as well as the maximum and minimum state of charge for the battery. The user can also specify the priority of devices as well as the maximum and minimum state of charge for the battery. The SOC versus power rule (curve) implemented by the control unit (e.g., the algorithm implemented by the control unit) may dynamically adopt the user's input 402 for the preference and priority of devices to turn off. FIG. 4 depicts the mapping 400 and output (forecasted time 404) based on the user defining the maximum SOC 406 and minimum SOC 408 as well as the sequence of the devices (appliances) 410-418 to be turned off as the state of charge of the battery decreases.

In an embodiment, the algorithm implemented by the control unit and/or a supervised machine learning algorithm can automatically set or give suggestions regarding a potential maximum SOC and minimum SOC based on monitored historical data (historical consumption data). For example, by monitoring the typical consumption of critical loads the algorithm can determine suggestions regarding the required SOC to suffice these loads for days or hours of operation in case of a power outage. The control unit and implemented algorithm can automatically map the sequence of the appliances 410-418 with the state of charge at which it will be turned off as depicted in FIG. 4 at 400. The control unit and implemented algorithm also generate and provide a user with the forecasted time 404 for each appliance 410-418 to be kept on when the power outage occurs as an output.

The forecasted time 404 may be presented via a hardware dashboard and user interface of a smart panel or control unit as well as presented via a user interface of an application or software dashboard of a mobile device or computer. In the example depicted in FIG. 4 the minimum SOC 408 is set to 20% which may be user specified or a default setting. The maximum SOC 406 is set to 70% which may be a default setting, determined by the control unit, or specified by a user. The SOC % or value at which each appliance will be turned off is then generated or determined by the control unit and implemented algorithm. In the example depicted in FIG. 4 the distribution is even between the minimum SOC 408 and maximum SOC 406. In embodiments, the control unit may collect and monitor historic data for electricity usage (historic power consumption data) and the user behavior pattern with each device (e.g., power consumption during usage, time periods for on states and off states for the devices). This information may be used to determine recommendations or suggestions for setting the minimum SOC, maximum SOC, and the priority of devices/appliances (e.g., user preferences/priority for the devices). The forecasted time 404 for each individual device 410-418 will be output and presented to a user. In embodiments, the runtime of a given device in an outage is calculated as Tₓ:

$${T}_{x} = \sum {T}_{i} + \frac{{E}_{C} * ( S O {C}_{x - 1} - S O {C}_{x )}}{Σ {P}_{i} + {P}_{c}} , i = 0 , 1 , 2 , … , x - 1$$

where Tᵢ is the runtime of individual devices/appliances that are turned off before appliance x is turned off, T₀=0; E_{c} is the battery energy capacity, SOCₓ is the SOC value at which the device/appliance x should be turned off, SOC₀ is the value of Max SOC, Pᵢ is the power of controllable appliances/devices remained on, P₀=0, P_{c} is the power of critical loads and non-controllable loads. The user preference and priority for the appliances/devices 410-418 is mapped 400 with the SOC in FIG. 4.

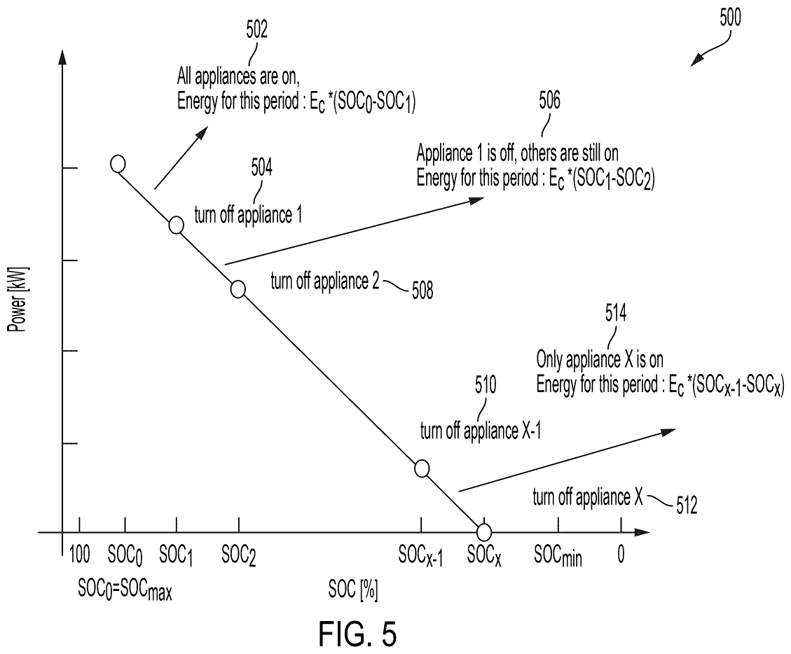

FIG. 5 illustrates an example graph 500 depicting certain aspects of the managing power consumption features including formulas according to embodiments described herein. As described herein, the SOC is used in the SOC versus power curve or rule as depicted in FIG. 5. When a power outage occurs, the battery is supplying all controllable appliances and the critical loads so the power demand is P=P₁+P₂+ . . . +Pₓ+P_{c} for the time period before turning off appliance/device 1 (504). The battery supplies such power until the SOC changes from SOC₀ to SOC₁ (502). Similar to FIG. 3, the example graph 500 includes the total power of controllable appliances/devices on the y-axis and the x-axis depicts the SOC of the battery.

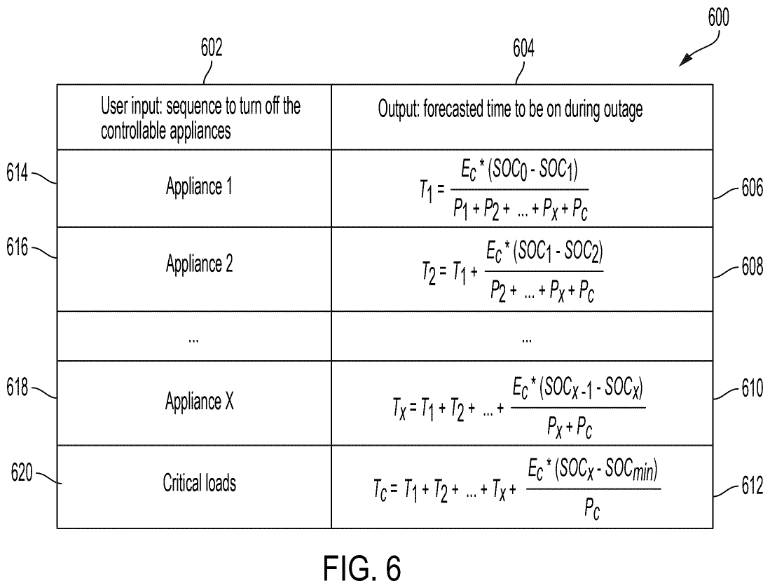

In embodiments, appliance 1 (504) will be kept on for the time period of T₁ as depicted in the table of FIG. 6. After the appliance 1 (504) is turned off, the total power demand changes to P=P₂+ . . . +Pₓ+P_{c}, and a total amount of energy of E_{c}*(SOC₁−SOC₂) 506 is used to supply appliances remaining on. The total time for appliance 2 (508) to be kept on, T₂, includes this period and T₁. After the appliance X-1 (510) is turned off, the battery would only supply appliance X and the critical loads. The time for appliance X 512 to be kept on includes the sum of the all the previous sections 514. Afterwards, the battery supplies the critical loads until the SOC reaches the minimum (which is defined by the manufacturer and can be set at zero or higher—depending on the manufacturer) at which point the building will no longer receive power from the battery.

FIG. 6 illustrates an example table 600 depicting users defining preferences and priorities of appliances as input 602 and a forecasted time to be provided as output 604 along with example formulations 606-612 used to determine the forecasted time for devices 614-620 according to an embodiment of the present disclosure.

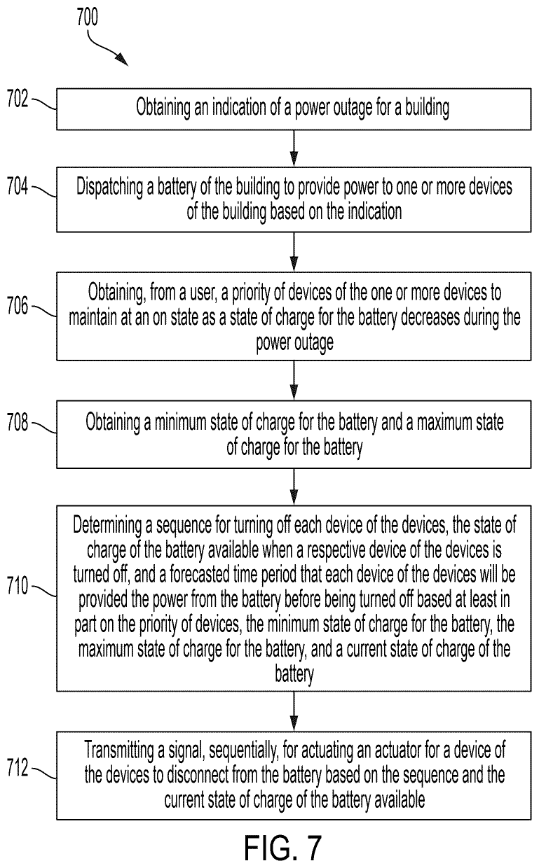

FIG. 7 illustrates a flow chart for managing power consumption according to embodiments described herein. FIG. 7 includes exemplary process 700 which may be performed by an environment or architecture such as in FIGS. 1, 2, 4, and 8 and by systems and components of FIGS. 1, 2, 4, and 8. However, it will be recognized that any of the following blocks may be performed in any suitable order and that the process 700 may be performed in any environment or architecture and by any suitable computing device and/or controller (control unit).

At step 702, the process 700 includes obtaining an indication of a power outage for a building. The process 700 includes, at 704, dispatching a battery of the building to provide power to one or more devices of the building based on the indication. In embodiments, the process 700 includes obtaining, from a user, a priority of devices of the one or more devices to maintain at an on state as a state of charge for the battery decreases during the power outage at 706. The process 700 includes at 708 obtaining a minimum state of charge for the battery and a maximum state of charge for the battery. In embodiments, the minimum state of charge for the battery and the maximum state of charge for the battery can be specified by a user or determined by the control unit/computer system based on historic power consumption data for the one or more devices of a building being monitored and controlled.

At 710 the process 700 includes determining a sequence for turning off each device of the devices, the state of charge of the battery available when a respective device of the devices is turned off, and a forecasted time period that each device of the devices will be provided the power from the battery before being turned off based at least in part on the priority of devices, the minimum state of charge for the battery, the maximum state of charge for the battery, and a current state of charge of the battery. The process 700 includes transmitting a signal, sequentially, for actuating an actuator for a device of the devices to disconnect from the battery based on the sequence and the current state of charge of the battery available at 712. In embodiments, the forecasted time period that each device of the devices that will be provided power from the battery before being turned off is provided for presentation or display to a user via a user device such as a mobile device, computer, or application. In an embodiment, the control unit or computer system may obtain historic power consumption data for the one or more devices of the building from current sensors of the one or more devices during a period of time, first information associated with planned power outages for the building during the period of time, and historic weather related information for an area associated with the building during the period of time.

This data or information may be used to train a supervised machine learning algorithm to predict a forecasted power outage and transmit instructions to charge the battery for the building to a maximum state of charge based on the forecasted power outage. For example, if historically a building loses power during weather storms in which wind speeds exceed 25 miles per hour, the supervised machine learning algorithm may learn that a pattern associated with this data point and the control unit implementing the algorithm can provide instructions prior to the storm arriving to charge the battery to a maximum state of charge. The supervised machine learning algorithm may also be trained to determine the maximum state of charge for the battery for the forecasted power outage using the historic power consumption data. For example, the supervised machine learning algorithm may learn that most outages related to an event can be supported by the battery at 80% of the maximum state of charge as opposed to 100%.

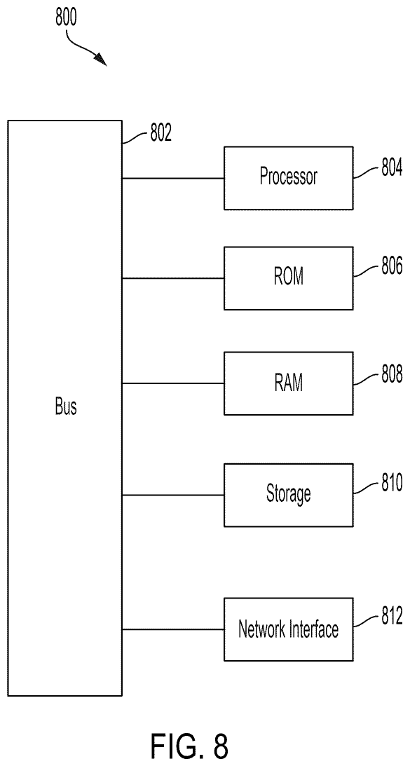

FIG. 8 illustrates a simplified block diagram of one or more devices or systems for managing power consumption according to embodiments of the present disclosure. FIG. 8 is a block diagram of an exemplary system or device 800 including a control unit for interacting with a load center, actuators, current sensors, voltage sensors, and other entities, devices, or third party entities as described herein with reference to FIGS. 1-7. The system 800 includes a processor 804, such as a central processing unit (CPU), and/or logic, that executes computer executable instructions for performing the functions, processes, and/or methods described herein. In some examples, the computer executable instructions are locally stored and accessed from a non-transitory computer readable medium, such as storage 810, which may be a hard drive or flash drive. Read Only Memory (ROM) 806 includes computer executable instructions for initializing the processor 804, while the random-access memory (RAM) 808 is the main memory for loading and processing instructions executed by the processor 804.

The network interface 812 may connect to a wired network or cellular network and to a local area network or wide area network or Bluetooth or other suitable communication methods such as those described herein with reference to the communication component or communication module. The system 800 may also include a bus 802 that connects the processor 804, ROM 806, RAM 808, storage 810, and/or the network interface 812. The components within the system 800 may use the bus 802 to communicate with each other. The components within the system 800 are merely exemplary and might not be inclusive of every component for embodiments described herein. For instance, in some examples, the system 800 might not include a network interface 812. In embodiments the system 800 may include one or more components for interacting with a machine or system executing an automated process such as actuators, output devices (e.g., speakers or user interfaces), power convertors or power supply systems. The system may use the one or more components for executing an action in response to identifying an anomaly such as ceasing operation of the machine or system, presenting an alarm or warning, visual or auditory, or reducing or otherwise cutting power to a machine to prevent further damage or catastrophic events. In embodiments the network interface 812 may communicate with one or more machines, computers, or systems within a facility or industrial environment to obtain historic operating data, test data, and/or model files for identifying anomalies which may represent issues, problems, or potential failure of a component of a machine or system.

While the disclosure has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and below. Additionally, statements made herein characterizing the disclosure refer to an embodiment of the disclosure and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for managing power consumption comprising:
obtaining an indication of a power outage for a building;
dispatching a battery of the building to provide power to one or more devices of the building based on the indication;
obtaining, from a user, a priority of devices of the one or more devices to maintain at an on state as a state of charge for the battery decreases during the power outage;
obtaining a minimum state of charge for the battery and a maximum state of charge for the battery;
determining a sequence for turning off each device of the devices, the state of charge of the battery available when a respective device of the devices is turned off, and a forecasted time period that each device of the devices will be provided the power from the battery before being turned off based at least in part on the priority of devices, the minimum state of charge for the battery, the maximum state of charge for the battery, and a current state of charge of the battery; and
transmitting a signal, sequentially, for actuating an actuator for a device of the devices to disconnect from the battery based on the sequence and the current state of charge of the battery available.

2. The computer-implemented method according to claim 1, wherein the minimum state of charge for the battery and the maximum state of charge for the battery are specified by the user.

3. The computer-implemented method according to claim 1, further comprising:
obtaining historic power consumption data for the one or more devices of the building from current sensors of the one or more devices; and
determining the minimum state of charge for the battery and the maximum state of charge for the battery based on the historic power consumption data for the one or more devices.

4. The computer-implemented method according to claim 1, further comprising providing, to a user device of the user, the forecasted time period that each device of the devices will be provided the power from the battery before being turned off.

5. The computer-implemented method according to claim 4, further comprising:
updating the forecasted time period as each device of the devices is turned off; and
providing, to the user device of the user, the updated forecasted time period.

6. The computer-implemented method according to claim 1, further comprising transmitting other signals for actuating actuators of the devices to turn the devices to the on state based on receiving another indication that the power outage for the building has ceased.

7. The computer-implemented method according to claim 6, further comprising transmitting instructions to charge the battery from a power source of the building based on the another indication that the power outage for the building has ceased.

8. The computer-implemented method according to claim 1, further comprising receiving, from a utility provider, a time period for a planned power outage for the building, wherein determining the sequence, the state of charge of the battery available when the respective device of the devices is turned off, and the forecasted time period that each device of the devices will be provided the power from the battery before being turned off is further based on receiving the time period for the planned power outage.

9. The computer-implemented method according to claim 8, further comprising transmitting instructions to charge the battery for the building to the maximum state of charge prior to the time period for the planned power outage based on receiving the time period.

10. The computer-implemented method according to claim 1, further comprising:
obtaining historic power consumption data for the one or more devices of the building from current sensors of the one or more devices during a period of time, first information associated with planned power outages for the building during the period of time, and historic weather related information for an area associated with the building during the period of time;
training a supervised machine learning algorithm to predict a forecasted power outage using the historic power consumption data, the first information, and the historic weather related information; and
transmitting instructions to charge the battery for the building to the maximum state of charge based at least in part on the forecasted power outage.

11. The computer-implemented method according to claim 10, wherein the supervised machine learning algorithm is further configured to determine the maximum state of charge for the battery for the forecasted power outage using the historic power consumption data.

12. A computer system for managing power consumption, the computer system comprising one or more hardware processors which, alone or in combination, are configured to provide for execution of the following steps:
obtaining an indication of a power outage for a building;
dispatching a battery of the building to provide power to one or more devices of the building based on the indication;
obtaining, from a user, a priority of devices of the one or more devices to maintain at an on state as a state of charge for the battery decreases during the power outage;
obtaining a minimum state of charge for the battery and a maximum state of charge for the battery;
determining a sequence for turning off each device of the devices, the state of charge of the battery available when a respective device of the devices is turned off, and a forecasted time period that each device of the devices will be provided the power from the battery before being turned off based at least in part on the priority of devices, the minimum state of charge for the battery, the maximum state of charge for the battery, and a current state of charge of the battery; and
transmitting a signal, sequentially, for actuating an actuator for a device of the devices to disconnect from the battery based on the sequence and the current state of charge of the battery available.

13. The computer system according to claim 12, further comprising:
obtaining historic power consumption data for the one or more devices of the building from current sensors of the one or more devices; and
determining the minimum state of charge for the battery and the maximum state of charge for the battery based on the historic power consumption data for the one or more devices.

14. The computer system according to claim 12, further comprising:
providing, to a user device of the user, the forecasted time period that each device of the devices will be provided the power from the battery before being turned off.

15. The computer system according to claim 12, further comprising:
updating the forecasted time period as each device of the devices is turned off; and
providing, to the user device of the user, the updated forecasted time period.

16. The computer system according to claim 12, further comprising transmitting other signals for actuating actuators of the devices to turn the devices to the on state based on receiving another indication that the power outage for the building has ceased.

17. The computer system according to claim 12, further comprising receiving, from a utility provider, a time period for a planned power outage for the building, wherein determining the sequence, the state of charge of the battery available when the respective device of the devices is turned off, and the forecasted time period that each device of the devices will be provided the power from the battery before being turned off is further based on receiving the time period for the planned power outage.

18. A tangible, non-transitory computer-readable medium having instructions thereon which, upon being executed by one or more processors, provide for managing power consumption by execution of the following steps:
obtaining an indication of a power outage for a building;
dispatching a battery of the building to provide power to one or more devices of the building based on the indication;
obtaining, from a user, a priority of devices of the one or more devices to maintain at an on state as a state of charge for the battery decreases during the power outage;
obtaining a minimum state of charge for the battery and a maximum state of charge for the battery
determining a sequence for turning off each device of the devices, the state of charge of the battery available when a respective device of the devices is turned off, and a forecasted time period that each device of the devices will be provided the power from the battery before being turned off based at least in part on the priority of devices, the minimum state of charge for the battery, the maximum state of charge for the battery, and a current state of charge of the battery; and
transmitting a signal, sequentially, for actuating an actuator for a device of the devices to disconnect from the battery based on the sequence and the current state of charge of the battery available.

19. The tangible, non-transitory computer-readable medium according to claim 18, further comprising providing, to a user device of the user, the forecasted time period that each device of the devices will be provided the power from the battery before being turned off.

20. The tangible, non-transitory computer-readable medium according to claim 18, further comprising transmitting other signals for actuating actuators of the devices to turn the devices to the on state based on receiving another indication that the power outage for the building has ceased.
